(19) United States
(12) Patent Application Publication
(10) Pub. No.: US 2026/0148748 A1
(43) Pub. Date: May 28, 2026

(54) METHOD FOR ADVERSARIAL TRAINING FOR UNIVERSAL SOUND SEPARATION

(71) Applicant: DOLBY INTERNATIONAL AB, Dublin (IE)

(72) Inventors: Jordi Pons Puig, Olot (ES); Santiago Pascual, Barcelona (ES); Joan Serra, Barcelona (ES); Emilian Postolache, Palestrina (IT)

(73) Assignee: DOLBY INTERNATIONAL AB, Dublin (IE)

(21) Appl. No.: 19/121,280

(22) PCT Filed: Sep. 18, 2023
(86) PCT No.: PCT/EP2023/075668

§ 371 Date: Apr. 15, 2025

Related U.S. Application Data
(60) Provisional application No. 63/440,568, filed on Jan. 23, 2023.
(60) Provisional application No. 63/498,794, filed on Apr. 27, 2023.

(30) Foreign Application Priority Data
Oct. 17, 2022 (ES) P202230890

(51) Int. Cl. G10L 21/0272; G10L 17/04; G10L 17/18

(52) U.S. Cl. CPC G10L 21/0272; G10L 17/04; G10L 17/18

(57) ABSTRACT

According to an aspect of the present disclosure there is provided a method for adversarial training of a separator (30) for universal sound separation of an audio mixture m of arbitrary sound sources S_{k=1, . . . ,K}, the method comprising: training a context-based discriminator (34) configured to provide a context-based loss cue based on a consideration of an input set of separated sound sources; and training the separator (30) to minimize a loss based on the context-based loss cue provided by the context-based discriminator (34); wherein training the context-based discriminator (34) comprises maximizing a loss based on a set of ground-truth sound sources and a fake set of separated sound sources, wherein the fake set of separated sound sources is sorted to match an order of the set of ground-truth sound sources, and wherein the fake set of separated sound sources comprises sources corresponding to separated sound sources estimated by the separator (30) and further comprises one or more ground-truth sound sources of the set of ground-truth sound sources.

### CROSS-REFERENCE TO RELATED APPLICATIONS

This application claims the benefit of priority from Spanish Patent Application No. P202230890 filed on 17 Oct. 2022, U.S. Provisional Application No. 63/440,568 filed on 23 Jan. 2023, and U.S. Provisional Application No. 63/498,794 filed on 27 Apr. 2023, each of which is incorporated by reference herein in its entirety.

### TECHNICAL FIELD OF THE INVENTION

The present invention relates in an aspect to a method for an adversarial training of a separator for universal sound separation.

### BACKGROUND OF THE INVENTION

The sound source separation problem consists in separating the sources that are present in an audio mixture. For example, music source separation consists in extracting the vocals, bass and drums from a music mixture—and speech source separation consists in separating each speaker from a mixture where several speakers talk simultaneously. One important characteristic of western popular music mixtures is that some musical instruments (e.g., vocals, bass and drums) appear consistently across songs. For this reason, most music source separation approaches assume that such instruments are always in the mix and separate vocals, bass, drums and ‘other sources’—where ‘other sources’ refers to any other source in the mix that is not vocals, bass or drums. Accordingly, most music source separation models are source specific. This contrasts with speech source separation, where the speakers present in the mix are not known in advance. Provided that one cannot assume knowing which speakers to separate in advance, most speech source separation models are speaker agnostic.

### GENERAL DISCLOSURE OF THE INVENTION

In a first aspect, there is provided a method for adversarial training of a separator for universal sound separation of an audio mixture m of arbitrary sound sources s_{k=1, . . . ,K}, the method comprising: training a context-based discriminator configured to provide a context-based loss cue based on a consideration of an input set of separated sound sources; and training the separator to minimize a loss based on the context-based loss cue provided by the context-based discriminator. The training of the context-based discriminator comprises maximizing a loss based on a set of ground-truth sound sources and a fake set of separated sound sources, wherein the fake set of separated sound sources is sorted to match an order of the set of ground-truth sound sources, and wherein the fake set of separated sound sources comprises sources corresponding to separated sound sources estimated by the separator and further comprises one or more ground-truth sound sources of the set of ground-truth sound sources.

In some embodiments, the fake set of separated sound sources is obtained by: obtaining a set of separated sound sources corresponding to a set of estimated separated sound sources [ŝ₁, . . . , ŝ_{K}] estimated by the separator from the audio mixture m; permuting the set of separated sound sources such that an order of the permuted set of separated sound sources matches an order of the set of ground-truth sound sources; and replacing one or more of the separated sound sources of the permuted set of separated sound sources with one or more ground-truth sound sources of the set of ground-truth sound sources to obtain the fake set of separated sound sources.

In a second aspect, there is provided a computer program product comprising computer program code portions configured to perform the method according to method of the first aspect when executed on a computer processor.

In a third aspect, there is provided a neural network-based system for universal sound separation of an audio mixture m of arbitrary sound sources s_{k=1 . . . ,K}, wherein the system is configured to perform the method according to the first aspect.

In a fourth aspect, there is provided a method for universal sound separation comprising: estimating by a separator a set of separated sound sources [ŝ₁, . . . , ŝ_{K}] from an audio mixture m of arbitrary sound sources s_{k=1, . . . ,K}, wherein the separator is trained using the method according to the first aspect.

In a fifth aspect, there is provided a neural network-based system for universal sound separation, comprising a separator configured to estimate a set of separated sound sources [ŝ₁, . . . , ŝ_{K}] from an audio mixture m of arbitrary sound sources s_{k=1, . . . ,K}, wherein the separator is trained using the method according to the first aspect.

### BRIEF DESCRIPTION OF THE DRAWINGS

The present invention will be described in more detail with reference to the appended drawings, showing currently preferred embodiments of the invention.

FIG. 1 illustrates an example of speech source separation.

FIG. 2 illustrates an example of music source separation.

FIG. 3 illustrates an example of universal sound separation.

FIG. 4 illustrates an instance-based adversarial loss for source separation.

FIG. 5a-b illustrate S-replacement context-based adversarial loss for source separation, 2- and 3-replacement examples (5a and 5b).

### DETAILED DESCRIPTION

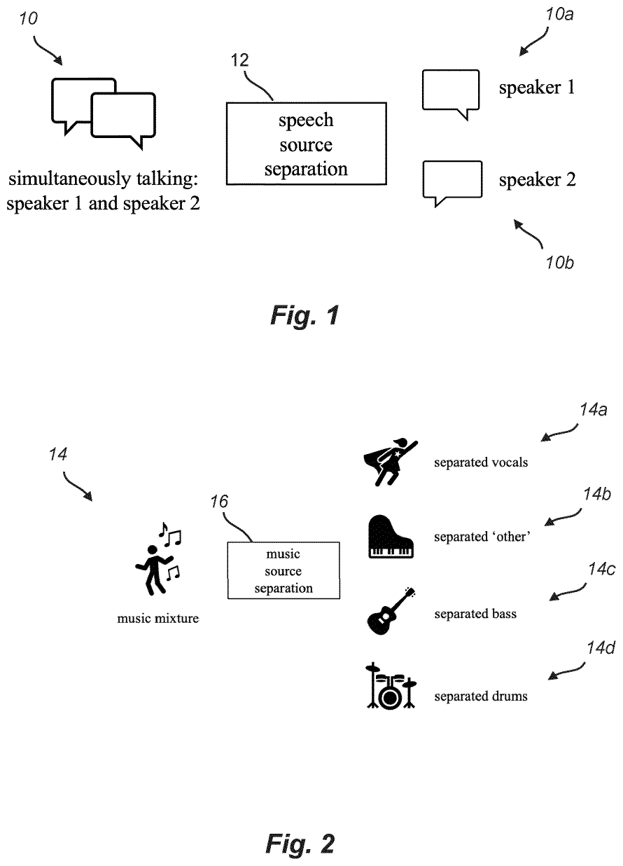

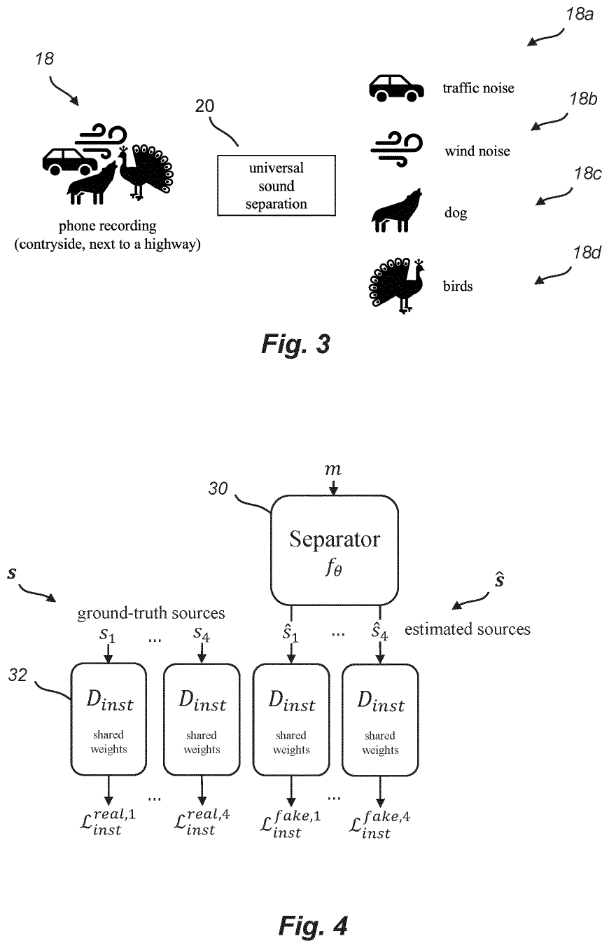

FIG. 1 is a schematical depiction of speech source separation 12 of two simultaneously talking speakers 10. The output of the speech source separation 12 is speaker 1 and 2 (reference signs 10a, 10b). FIG. 2 is a schematical depiction of music source separation 16 of a music mixture 14. The music source separation 16 outputs separated music sources including vocals 14a, ‘other’ 14b, bass 14c and drums 14d. FIG. 3 is meanwhile a schematical depiction of universal sound separation 20 of a mixture of arbitrary sources which in the illustrated example is a phone recording 18 (countryside, next to a highway). The separation 20 outputs separated sound sources including traffic noise 18a, wind noise 18b, dog 18c and birds 18d.

Recently, deep learning based universal sound separation was proposed. It consists in building source agnostic models that can separate any source given an arbitrary audio mix. Differently from music source separation, universal separation is not source specific and can separate any source given an arbitrary audio mix. This means that a universal sound separation system can separate music mixture, but also can separate user-generated phone recordings containing animals and traffic noise. Note that the task of universal sound separation is similar to speech source separation since both rely on speaker source agnostic models. In short universal sound separation models are source agnostic and are not constrained to a specific domain (like music or speech) such that they can separate any source given an arbitrary audio mixture. The present invention is framed within the context of deep learning based universal sound separation.

In this section permutation invariant training (PIT) is described. PIT is a technique that is commonly used for training deep learning based universal source separation models. Next, PIT is extended with adversarial training and, finally, an embodiment of adversarial PIT for universal sound separation is presented.

### Permutation Invariant Training (PIT)

Audio mixtures m of length L composed of K′ arbitrary sources s are considered as follows:

$$m = {\sum }_{k = 1}^{{K}^{′}} {s}_{k} .$$

In universal sound separation, the separator model f_{θ} predicts the K estimated sources ŝ=f_{θ}(m) out of the mixture m. PIT optimizes the learnable parameters θ of the separator via minimizing the following permutation invariant loss:

$${ℒ}_{PIT} = {min}_{P} {\sum }_{k = 1}^{K} ℒ ( {s}_{k} , {[ P \hat{s} ]}_{k} ) , \qquad ( 1 )$$

where such minimization is performed over the set of all permutation matrices P and [symbol] can be any regression loss. P* is denoted as the optimal permutation matrix minimizing Eq. (1). Note that a permutation invariant loss is required to build source agnostic models, because the outputs of f_{θ} can be any source and in any order. As such, the model must not focus on predicting one source type per output, and any possible permutation of output sources must be equally correct from the perspective of the loss. In order to accommodate for that, PIT is employed such that the predictions of the model do not depend on any source type or any specific order. Finally, note that the separator outputs K sources and, in case a mixture contains K′<K sources, the disclosure sets sₖ=0's for k>K′. A commonly used [symbol] is the negative threshold signal to noise (SNR):

$${ℒ}_{τ SNR} = - 10 {log}_{10} \frac{{‖ {s}_{k} ‖}^{2}}{{‖ {s}_{k} - {\hat{s}}_{k} ‖}^{2} + τ {‖ {s}_{k} ‖}^{2}} \qquad ( 2 )$$

where τ=10^{-SNR}^{ₘₐₓ} determines the maximum SNR (signal-to-noise ratio) value, preventing the loss to be pathologically amplified when ∥sₖ−ŝₖ∥ is close to zero. Note that the numerator in Eq. (2) does not depend on θ, so the loss is equivalent to the thresholded logarithmic mean squared error:

$${ℒ}_{logMSE} = 10 {log}_{10} ( {‖ {s}_{k} - {\hat{s}}_{k} ‖}^{2} + τ {‖ {s}_{k} ‖}^{2} ) . \qquad ( 3 )$$

Also note that Eq. (3) is unbounded when the target source is silent sₖ=0's. In that case, one can use a different loss based on thresholding with respect to the mixture (not silent):

$${ℒ}_{{s}_{k = 0}} = 10 {log}_{10} ( {‖ {\hat{s}}_{k} ‖}^{2} + τ {‖ m ‖}^{2} ) . \qquad ( 4 )$$

To sum up, a well-behaved [symbol] for PIT that the disclosure may use for universal sound separation is as follows:

$$ℒ = \{ \begin{matrix}10 {log}_{10} ( {‖ {\hat{s}}_{k} ‖}^{2} + τ {‖ m ‖}^{2} ) & if s = 0 \\ 10 {log}_{10} ( {‖ {s}_{k} - {\hat{s}}_{k} ‖}^{2} + τ {‖ {s}_{k} ‖}^{2} ) & otherwise\end{matrix} .$$

### Adversarial Permutation Invariant Training

As described below, PIT is extended with adversarial training. Adversarial training in the context of source separation consist in simultaneously training two models: the separator f_{θ} producing plausible separations ŝ, and a discriminator D that dictates whether the separations ŝ are produced by the separator f_{θ} (fake) or are ground-truth separations s from the dataset (real). Under this setup, the goal of the separator is to estimate (fake) separations that are as close as possible to the ones from the dataset (real) such that D misclassifies the estimated sources ŝ as real by leveraging an adversarial loss. Some aspects of the present invention combines variations of the following discriminators: an instance-based discriminator Dᵢₙₛₜ and a novel S-replacement context-based discriminator D_{ctx,S}. Each discriminator has different roles and are applicable at various domains, such as: waveforms, magnitude STFTs, filter-bank, and/or masks. Without loss of generality, systems and methods are first presented in the waveform domain and it is later shown that one can use (and combine) multiple discriminators (Dᵢₙₛₜ and D_{ctx,S}) operating at various domains to train f_{θ} adversarially to produce realistic separations for universal sound separation.

### Instance-Based Adversarial Loss

The role of the instance-based discriminator Dᵢₙₛₜ is to provide loss cues on the realness of the separated source alone, without any context. To do so, Dᵢₙₛₜ assesses the realness of each source individually:

$$[ {s}_{1} ] / [ {\hat{s}}_{1} ] … [ {s}_{K} ] / [ {\hat{s}}_{K} ] ,$$

where the brackets [·] define the Dᵢₙₛₜ's input, and left/right denote real/fake separations (not division). In this case, individual real/fake separations are fed to Dᵢₙₛₜ that learns to classify separations as real/fake. Dᵢₙₛₜ is trained to maximize:

$${ℒ}_{inst} = \frac{1}{K} {\sum }_{k = 1}^{K} {ℒ}_{inst}^{real , k} + {ℒ}_{inst}^{fake , k} , where : \qquad ( 5 )$$

$${ℒ}_{inst}^{real , k} = log ( {D}_{inst} ( {s}_{k} ) ) ,$$

$${ℒ}_{inst}^{fake , k} = log ( 1 - {D}_{inst} ( {\hat{s}}_{k} ) ) ,$$

Yet, note that adversarial setups can be unstable and challenging to train. For this reason, alternative adversarial training losses have been proposed like the least-squares generative adversarial networks (LSGAN) or metric GAN. In some embodiments, the hinge (adversarial) loss may be utilized:

$${ℒ}_{inst}^{real , k} = min ( 0 , - 1 + {D}_{inst} ( {s}_{k} ) ) ,$$

$${ℒ}_{inst}^{fake , k} = min ( 0 , - 1 - {D}_{inst} ( {\hat{s}}_{k} ) ) ,$$

In FIG. 4 is shown an example of an instance-based discriminator Dᵢₙₛₜ (reference sign 32) of a neural network-based system also comprising a separator f_{θ} (reference sign 30). The separator 30 is configured (trained) to estimate a set of separated sound sources ŝ from the audio mixture m. In the illustrated example, K=4 and the separator 30 thus estimates the sources ŝ=[ŝ₁, ŝ₂, ŝ₃, ŝ₄] from the audio mixture m. The instance-based discriminator 32 is configured to provide an instance-based loss cue based on a consideration of an individual input separated sound source (e.g. ŝ₁, ŝ₂, ŝ₃ or ŝ₄). The instance-based discriminator 32 of the illustrated example is hence configured to operate in the waveform domain. Hence, the sound source input to the instance-based discriminator 32 is represented in the waveform domain. The instance-based loss cue (e.g. Dᵢₙₛₜ(ŝₖ)) may also be referred to as an instance-based adversarial loss cue, or an instance-based adversarial cue. As will be described in further detail herein, the separator 30 may be trained by minimizing a loss based on the instance-based loss cue provided by the instance-based discriminator 32.

Note in FIG. 4 that the discriminator 32 (i.e. Dᵢₙₛₜ) assesses each source instance alone and classifies them as real or fake, and this is done for all estimated and ground-truth sources pairs. Previous works already explored instance-based discriminators. However, these are typically employed in source specific setups where each Dᵢₙₛₜ is specialized in a source type. For example, in music source separation source specific discriminators are used for bass, guitar, drums and vocal sources. Or in speech source separation Dᵢₙₛₜ is only trained to assess speech signals. According to the present disclosure, each Dᵢₙₛₜ for universal sound separation, however, is not specialized in any source (they are source agnostic) and assess the realness of any audio, regardless of its source type.

### S-Replacement Context-Based Adversarial Loss

The role of the context-based discriminator with S-replacement D_{ctx,S} is to provide loss cues on the realness of the separated sources, considering all the sources present in the mix (the context):

$$[ {s}_{1} , … , {s}_{K} ] / [ {\overline{s}}_{1} , … , {\overline{s}}_{K} ]$$

where the brackets [·] define the D_{ctx,S}'s input, and left/right denote real/fake separations (not division). In this case, all the separations are fed jointly to provide context to D_{ctx,S} that learns to classify such separations as real/fake. In addition, D_{ctx,S} can also be conditioned on the input mixture m:

$$[ m , {s}_{1} , … , {s}_{K} ] / [ m , {\overline{s}}_{1} , … , {\overline{s}}_{K} ]$$

The fake examples contain entries s̅ₖ, obtained by randomly sampling S∈{1, . . . , K} indices k and replacing the estimated sources

$${\hat{s}}_{k}^{*}$$

by the ground-truth sources sₖ:

$${\overline{s}}_{k} = \{ \begin{matrix}{s}_{k} , if k is randomly sampled \\ {\hat{s}}_{k}^{*} , otherwise\end{matrix} \qquad ( 6 )$$

where

$${\hat{s}}_{k}^{*} = {[ P * \hat{s} ]}_{k}$$

with P* being the optimal permutation matrix minimizing Eq. (1). To further understand the role of P*, consider as an example a case where K=4 and where the estimated sources [ŝ₁, ŝ₂, ŝ₃, ŝ₄] are sorted

$$[ {\hat{s}}_{1}^{*} , {\hat{s}}_{2}^{*} , {\hat{s}}_{3}^{*} , {\hat{s}}_{4}^{*} ]$$

to match the order of the ground-truth [s₁, s₂, s₃, s₄] (because the source agnostic estimations do not necessarily need to match the same order as the ground-truth). Accordingly, e.g., a possible input to D_{ctx,S}=2 with K=4 is:

$$[ m , {s}_{1} , {s}_{2} , {s}_{3} , {s}_{4} ] / [ m , {s}_{1} , {\hat{s}}_{2}^{*} , {s}_{3} , {\hat{s}}_{4}^{*} ] .$$

E.g., the permutation of the estimated sources enables a selected source

$${\hat{s}}_{k}^{*}$$

to be replaced with its corresponding ground-truth sₖ.

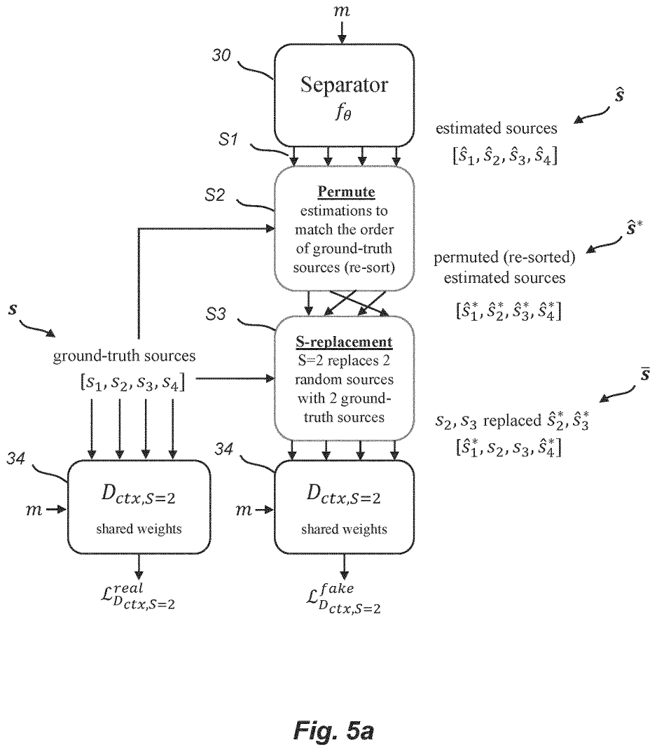

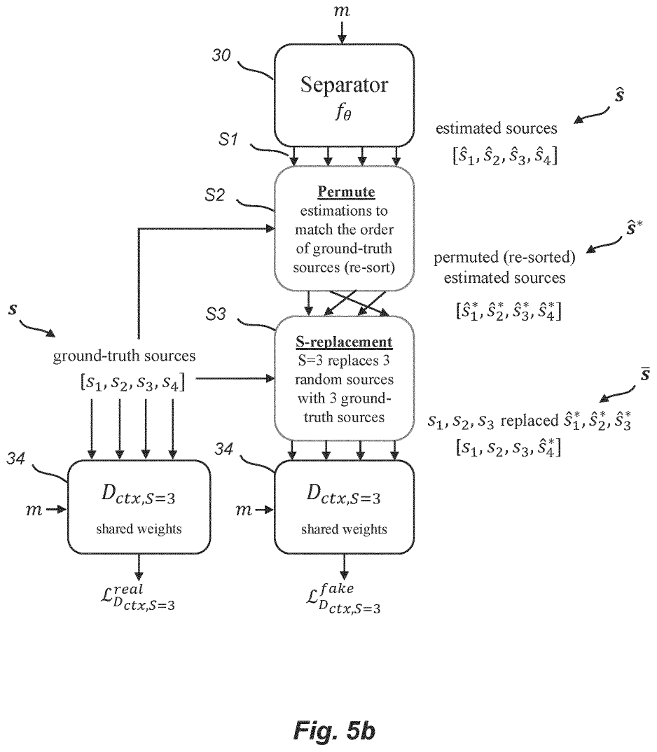

Additional examples with K=4 are also depicted in FIG. 5a-b, showing an example of a context-based discriminator D_{ctx,S}=2 or 3 (reference sign 34) of a neural network-based system also comprising the separator f_{θ} (reference sign 30). Like in FIG. 4, K=4 and the separator 30 thus estimates the sources ŝ=[ŝ₁, ŝ₂, ŝ₃, ŝ₄] from the audio mixture m. The context-based discriminator 34 is configured to provide a context-based loss cue based on a consideration of an input set of separated sound sources (e.g. s̅=[s̅₁, s̅₂, s̅₃, s̅₄]). The context-based discriminator 34 of the illustrated example is hence configured to operate in the waveform domain. Hence, the input set of separated sound sources are represented in the waveform domain. The context-based loss cue (e.g. D_{ctx,S} (m, s̅₁, . . . , s̅₄) may also be referred to as a context-based adversarial loss cue, or a context-based adversarial cue. As will be described in further detail herein, the separator 30 may be trained by minimizing a loss based on the context-based loss cue provided by the context-based discriminator 34. In accordance with the preceding discussion, training of the context-based discriminator 34 may comprise maximizing a loss based on a set of ground-truth sound sources s=[s₁, s₂, s₃, s₄] and a fake set of separated sound sources s̅=[s̅₁, s̅₂, s̅₃, s̅₄]. As illustrated in FIGS. 5a and 5b the fake set of separated sound sources s is obtained by:
obtaining a set of separated sound sources [ŝ₁, ŝ₂, ŝ₃, ŝ₄] (i.e. represented in the waveform domain) estimated by the separator 30 from the audio mixture m (step S1);
permuting the set of separated sound sources [$1, $2, $3, $4] such that an order of the permuted set of separated sound sources

$$[ {\hat{s}}_{1}^{*} , {\hat{s}}_{2}^{*} , {\hat{s}}_{3}^{*} , {\hat{s}}_{4}^{*} ]$$

matches an order of the set of ground-truth sound sources [s₁, s₂, s₃, s₄] (step S2); and
replacing one or more of the separated sound sources

$${\hat{s}}_{k = 1 , 2 , 3 , 4}^{*}$$

of the permuted set of separated sound sources

$$[ {\hat{s}}_{1}^{*} , {\hat{s}}_{2}^{*} , {\hat{s}}_{3}^{*} , {\hat{s}}_{4}^{*} ]$$

with one or more ground-truth sound sources s_{k=1,2,3,4} of the set of ground-truth sound sources [s₁, s₂, s₃, s₄] to obtain the fake set of separated sound sources [s̅₁, s̅₂, s̅₃, s̅₄] (step S3).

Thereby, a fake set of separated sound sources 5 may be obtained, wherein § is sorted to match an order of the set of ground-truth sound sources s, and wherein the fake set of separated sound sources s comprises sources (i.e. entries) corresponding to separated sound sources ŝ=[ŝ₁, ŝ₂, ŝ₃, ŝ₄] estimated by the separator 30 and further comprises one or more ground-truth sound sources of the set of ground-truth sound sources s. As follows from the preceding discussion, the parameter Sin D_{ctx,S} denotes the number of ground-truth sound sources sₖ of the fake set of separated sound sources s. S hence denotes the number of separated sound sources

$${\hat{s}}_{k}^{*}$$

replaced by ground-truth sound sources sₖ. In some embodiments, S is equal to or greater than 2, such as S=3. More generally, S may be greater than 0.

Note that using D_{ctx,S}=0 with K=4 would imply the following input:

$$[ m , {s}_{1} , {s}_{2} , {s}_{3} , {s}_{4} ] = [ m , {\hat{s}}_{1}^{*} , {\hat{s}}_{2}^{*} , {\hat{s}}_{3}^{*} , {\hat{s}}_{4}^{*} ] ,$$

that is equivalent to the standard context-based adversarial loss (without S-replacement) already used for speech source separation. Hence, the disclosure consists in generalizing these systems and methods for universal sound separation and to propose the S-replacing schema that improves the quality of the separations.

Formally, D_{ctx,S} is trained to maximize the following loss:

$${ℒ}_{ctx , S} = {ℒ}_{ctx , S}^{real} + {ℒ}_{ctx , S}^{fake} where : \qquad ( 7 )$$

$${ℒ}_{ctx , S}^{real} = log ( {D}_{ctx , S} ( m , {s}_{1} , ... , {s}_{K} ) ) ,$$

$${ℒ}_{ctx , S}^{fake} = log ( 1 - {D}_{ctx , S} ( m , {\overline{s}}_{1} , ... , {\overline{s}}_{K} ) ) .$$

Yet, remember that alternative adversarial training losses can be used to make adversarial training more stable. In some embodiments, the hinge (adversarial) loss may be utilized:

$${ℒ}_{ctx , S}^{real} = min ( 0 , 1 - {D}_{ctx , S} ( m , {s}_{1} , ... , {s}_{K} ) ) ,$$

$${ℒ}_{ctx , S}^{fake} = min ( 0 , 1 + {D}_{ctx , S} ( m , {\overline{s}}_{1} , ... , {\overline{s}}_{K} ) ) .$$

Finally, note that since the disclosure describes an embodiment of estimating P* with Eq. (1), the S-replacement context-based adversarial loss is also permutation invariant. The difference with standard PIT is that the S-replacement context-based adversarial loss does not rely on optimizing the parameters of f_{θ} with respect to the regressor loss in Eq. (1). The discriminator D_{ctx,S} defines a loss related to the realness of the separations considering an inter-source global context, unlike Dᵢₙₛₜ, which captures a local context related to a single source. Also, related to Dᵢₙₛₜ, note that the instance-based adversarial discriminator does not require computing P* to obtain a permutation invariant output since Dᵢₙₛₜ lacks the context required to assess the order of the sources.

### Multi-Discriminator Training

The above embodiment presents Dᵢₙₛₜ and D_{ctx,S} in the waveform domain:

$${D}_{inst}^{wave} and {D}_{ctx , S}^{wave} .$$

In the following, further embodiments introduce the discriminators Dᵢₙₜₛ and D_{ctx,S} in the magnitude STFT

$$( {D}_{inst}^{STFT} and {D}_{ctx , S}^{STFT} )$$

and mask

$$( {D}_{inst}^{mask} and {D}_{ctx , S}^{mask} )$$

domains and explain how to combine them for improving the quality of the separations. The motivation behind combining multiple discriminators is to enable the loss guiding the separator f_{θ} to be based on a richer set of cues. Note that instance- and context-based discriminators D can provide different perspectives of the same signal in various domains: waveform, magnitude STFT and mask. For example, predicted masks are typically used to filter the input mixture, and the proposed discriminators can contribute assessing the realness of the masks together with assessing the realness of the waveforms and the magnitude STFTs. The disclosure is the first to explore multiple discriminators D for universal source separation. The short-time Fourier transform (STFT) of a mixture m is defined as M=STFT(m). The magnitude STFT is obtained by taking the absolute value of M in the complex domain, namely |M|. |Sₖ| and |Ŝₖ| are denoted as the magnitude STFTs of ground-truth and estimated sources, respectively. Ratio masks Rₖ (0 to 1 valued) are obtained from the magnitude STFT and are used to filter sources out from the mixture:

$${R}_{k} = \frac{\vert {S}_{k} \vert}{{\sum }_{k = 1}^{K} \vert {S}_{k} \vert}$$

where: Sₖ=M⊙Rₖ and ⊙ denotes the Hadamard (element-wise) product. While for this example the ratio masks Rₖ is used, it is noted that this procedure generalizes to other kind of masks (e.g., like binary masks). Following the same notation as above, the input to the instance-based

$${D}_{inst}^{STFT} and {D}_{inst}^{mask}$$

is defined as follows:

$$\begin{matrix}{D}_{inst}^{STFT} & [ \vert {S}_{1} \vert ] / [ \vert {\hat{S}}_{1} \vert ] … [ \vert {S}_{K} \vert ] / [ \vert {\hat{S}}_{K} \vert ] \\ {D}_{inst}^{mask} & [ {R}_{1} ] / [ {\hat{R}}_{1} ] … [ {R}_{K} ] / [ {\hat{R}}_{K} ]\end{matrix}$$

and, e.g., for the context-based

$${D}_{ctx , S}^{S T F T} and {D}_{ctx , S}^{m a s k}$$

as follows:

$$\begin{matrix}{D}_{ctx , S}^{S T F T} & [ \vert M \vert ] , [ \vert {S}_{1} \vert ] , … , [ \vert {S}_{K} ] / [ \vert M \vert , \vert {\overline{S}}_{1} \vert , … \vert {\overline{S}}_{K} \vert ] \\ {D}_{ctx , S}^{m a s k} & [ \vert M \vert , {R}_{1} , … , {R}_{K} ] / [ \vert M \vert , {\overline{R}}_{1} , … , {\overline{R}}_{K} ]\end{matrix} ,$$

where |S̅ₖ| and R̅ₖ entries follow the same S-replacement procedure as in Eq. (6). Here, the optimal permutation matrix P* required for re-sorting the fake examples is computed considering the L1 loss between magnitude STFTs or masks.

As noted above, one can combine multiple discriminators D to increase the quality of the separations. For example, at least a first and a second context-based discriminator configured to operate in different domains can be combined. Additionally, at least a first and a second instance-based discriminator configured to operate in different domains can be combined. For example, the discriminators (i.e. context- or instance-based) may be configured to operate in a respective one of a waveform domain, a magnitude STFT domain, a filter-bank domain or a mask domain (e.g.

$${D}_{ctx , S}^{S T F T}$$

may be combined with

$${D}_{ctx , S}^{wave} and / or {D}_{ctx , S}^{mask} ,$$

while

$${D}_{inst}^{STFT}$$

may be combined with

$${D}_{i n s t}^{w a v e} and / or {D}_{i n s t}^{m a s k} ) .$$

Instance- and context-based discriminators D can be jointly trained to maximize Eqs. (5) and (7) in different domains. For example, in addition to training each D alone, one can train:

$${D}_{i n s t}^{w a v e} with {D}_{ctx , S}^{w a v e} , {D}_{i n s t}^{S T F T} with {D}_{ctx , S}^{S T F T} , {D}_{i n s t}^{m a s k} with {D}_{c tx , S}^{m a s k}$$

or one could combine all the proposed discriminators D together (at the expense of a longer training time). Note that the more discriminators D one uses, the more computationally expensive it is to run the loss and the longer it takes to run training. Also note that adding more discriminators D does not affect inference time.

### Separator Loss

When using adversarial training, the separator model f_{θ} is trained such that it produces separations that are misclassified by the discriminator. Thus meaning that the estimated separations ŝ (fake) are misclassified as ground truth separations s (real) by the discriminator D. In order to do so, during every adversarial training step, the discriminators are first updated (without updating the separator) based on [symbol] ᵢₙₛₜ, [symbol] _{ctx,S} or any combination of losses in any of the above domains. Then, [symbol] ᵢₙₛₜ is minimized to train the separator (without updating the discriminator). For example, the following separator loss is minimized when using

$${D}_{i n s t}^{w a v e}$$

$$( {D}_{i n s t}^{w a v e}$$

is frozen:

$${ℒ}_{s e p} = \frac{1}{K} {\sum }_{k = 1}^{K} log ( 1 - {D}_{i n s t}^{w a v e} ( {\hat{s}}_{k} ) )$$

or the disclosure minimizes the following loss when using

$${D}_{c tx , S}^{w a v e} :$$

$${ℒ}_{s e p} = \frac{1}{K} {\sum }_{k = 1}^{K} log ( 1 - {D}_{ctx , S}^{w a v e} ( m , {\overline{s}}_{1} , … {\overline{s}}_{K} ) )$$

or, as another example, when training with two discriminators (like

$${D}_{i n s t}^{S T F T} , {D}_{ctx , S}^{S T F T} )$$

the loss to be minimized is as follows:

$${ℒ}_{s e p} = \frac{1}{K} {\sum }_{k = 1}^{K} log ( 1 - {D}_{i n s t}^{S T F T} ( \vert {\hat{S}}_{k} \vert ) ) + log ( 1 - {D}_{c t x S}^{S T F T} ( \vert M \vert , \vert {\overline{S}}_{1} \vert , … , \vert {\overline{S}}_{K} \vert ) )$$

Again, remember that alternative adversarial training losses can be used to make adversarial training more stable. One can also explore using the hinge loss as follows:

$${ℒ}_{s e p} = - \frac{1}{K} {\sum }_{k = 1}^{K} {D}_{i n s t}^{S T F T} ( \vert {\hat{S}}_{k} \vert ) - {D}_{c tx , S}^{S T F T} ( \vert M \vert , \vert {\overline{S}}_{1} \vert , … , \vert {\overline{S}}_{K} \vert )$$

While the disclosure is not presenting all the possible loss combinations for the sake of brevity, from these examples one can easily infer any of the possible combinations described throughout the disclosure (including the hinge loss variations). Finally, one can also extend adversarial PIT with the standard PIT regression loss in Eq. (1):

$${ℒ}_{s e p} + {λℒ}_{P I T}$$

where is a positive weighting factor. Interestingly, all previous works using adversarial PIT for speech source separation (not universal sound separation) rely on [symbol] ₛₑₚ+ [symbol] _{PIT}. However, given the strong training loss provided by the multiple discriminators and D_{ctx,S} (with S-replacement), our setup allows dropping the regression PIT loss to rely on a purely adversarial setup for the first time.

### Architecture

This section introduces an exemplary embodiment of the architecture of the system used to develop the disclosure. As such, is just one possible embodiment of it. The disclosure does not depend on the here described separator, discriminator or adversarial loss.

### Exemplary Embodiment of Separators

The input mixture m is sampled at 16 kHz with L=160000 (10 s). First, the input is mapped to the STFT domain M=STFT(m), with windows of 32 ms and 25% overlap. From M the magnitude STFT |M| is obtained and input to a U-Net g_{θ} as a tensor of shape [F,T] (F=256 frequency bins, T=1250 frames). The output of the U-Net g_{θ} is designed to predict a ratio mask. To that end, a softmax layer is applied across the source dimension K:\hat{R}=σ(g_{θ}(|M|)), such that the sum of the predicted sources is the input mixture. Then the estimated STFTs are filtered out from the mixture: Ŝₖ=M⊙\hat{R}ₖ. Finally, the inverse STFT is used to obtain the separated waveforms: ŝ=f_{θ}(m)=iSTFT(Ŝ)∈ [symbol] ^{K×T} The U-NET g_{θ} comprises an encoder, a bottleneck, and a decoder.

The encoder is a sequence of 4 blocks, each composed of 2 ResNet blocks followed by a downsampler. Each ResNet block is composed of the following layers: group-norm, SiLU non-linearity, 1D convolutional neural network (1D-CNN), group-norm, SiLU, dropout and 1D-CNN followed by a skip-connection, where the 1D-CNN layers have a kernel size=3 and stride=1. Using 1D-CNNs results in a more efficient architecture memory-wise and is the choice of other architectures for source separation, e.g., TDCN++. The dropout probability is set to 0:1 and a group size of 32 in group-norm is used. The downsampling layer is a 1D-CNN (kernel size=3, stride=2). The channel sequence across the encoder is [256, 512, 512, 512].

The bottleneck block consists of the following layers: ResNet (as defined above), self-attention [26] and ResNet, with all layers maintaining the 512 channels. The decoder block is composed of 4 blocks, reversing the structure of the encoder, with upsamplers in place of downsamplers, resulting in the following channel sequence: [512, 512, 512, 256]. The upsamplers perform linear interpolation followed by a 1D-CNN layer (kernel size=3, stride=1). Following the standard Unet structure, the outputs of each encoder block are injected as input (at its corresponding block level) to the decoder block. The encoder features are concatenated with the inputs of the decoder ResNet blocks along the channel dimension (a linear layer adapts the channel number, if necessary). 3 ResNet blocks are used in each decoder block, differently from the encoder that uses 2. The feature-maps from the 2 ResNet encoder blocks are concatenated with the input of the first 2 ResNet decoder blocks, and the output of the downsampling layer of the encoder is concatenated with the input of the third ResNet decoder block. A final linear layer adapts the output to be able to predict the expected number of sources (K=4), what results in the following output: g_{θ}(|M|)∈ [symbol] ^{K×F×T}.

### Exemplary Embodiment of Discriminators

Discriminators are CNNs and output a single scalar.

$${D}_{i n s t}^{w a v e} and {D}_{c tx , S}^{w a v e}$$

share the same architecture: x4 1D-CNN layers (kernel size=4, stride=3) interleaved by LeakyRe-Lus (with a negative slope of 0:2), resulting in the following channels sequence: [C, 128, 256, 256, 512], where C=1 for

$${D}_{i n s t}^{w a v e}$$

### and C=5 for

$${D}_{c tx , S}^{w a v e}$$

when conditioned on m and K=4. Then, the 512 channels are reduced to 1 with a 1D-CNN layer (kernel size=4, stride=1), and the output layer (mapping the resulting vector to a scalar) is linear.

$${D}_{i n s t}^{S T F T} , {D}_{ctx , S}^{S T F T} , {D}_{i n s t}^{mask} , {D}_{ctx , S}^{mask}$$

follow the same architectures as

$${D}_{i n s t}^{w a v e} and {D}_{c tx , S}^{w a v e} ,$$

with the difference that 1D-CNNs are 2D (kernel size=4 4, stride=3 3) and the number of channels is halved: [C, 64, 128, 128, 256].

### Exemplary Embodiment of Adversarial Loss

Provided that it exists evidence that the standard adversarial loss (also presented in this disclosure) can be challenging to train, the disclosure's experiments relied on the hinge loss variant of adversarial training. That said, the disclosure is not dependent on any specific adversarial loss and any could be used. Finally, the disclosure successfully combined the disclosure's adversarial PIT schema with PIT regression ( [symbol] ₛₑₚ+λ [symbol] _{PIT}) and, differently from previous works, the disclosure's results show that [symbol] _{PIT} is not strictly necessary and can be dropped. This may be possible because of the rich loss provided by the multiple D's and the strong guidance by the D_{ctx,S} (relying on S-replacement).

### Adversarial PIT for Speech Source Separation

Adversarial PIT for speech source separation is related to the disclosure. As noted in the background, speech source separation works target at developing speaker agnostic models. A common technique to do so consists in using PIT to develop a speaker agnostic model in a similar fashion as one aims to develop source agnostic models. Speech source separation field also extended PIT with adversarial training. Table 1 summarizes how the disclosure compares with the prior systems on adversarial PIT for speech source separation:

TABLE 1

| Previous works | | | | | |
|---|---|---|---|---|---|
| on two | | | | | |
| speakers | | | Discriminators' | | |
| source | Discriminators' input | multiple | input audio | regression | Adversarial |
| separation: | format (fake/real) | discriminators? | representation | PIT loss? | loss? |
| CBLDNN [1] | [m, ŝ₁, ŝ₂]/[m, s₁, s₂] | no | magnitude | magnitude | LSGAN |
| | | | STFT | STFT | |
| SSGAN-PIT | [m, ŝ₁, ŝ₂]/[m, s₁, s₂] | no | magnitude | magnitude | LSGAN |
| [2]: variant (i) | | | STFT | STFT | |
| SSGAN-PIT | [ŝ₁, ŝ₂]/[s₁, s₂] | no | magnitude | magnitude | LSGAN |
| [2]: variant (ii) | | | STFT | STFT | |
| SSGAN-PIT | [ŝ₁]/[s₁] and [ŝ₂]/[s₂] | no | magnitude | magnitude | LSGAN |
| [2]: variant (iii) | | | STFT | STFT | |
| Furcax [3] | [ŝ₁, ŝ₂]/[s₁, s₂] | no | waveform | waveform | LSGAN |
| Conv-TasSan | [ŝ₁, ŝ₂, s₁, s₂]/ | no | waveform | waveform | MetricGAN |
| [4] | [s₁, s₂, s₁, s₂] | | | | |
| Our | any above, extended to | yes, for | any above, in | optional | HingeGAN |
| generalized | more sources, and with | better quality | addition to | (not | (or any |
| method for | D_{ctx, S} with S- | | masks | necessary) | above) |
| universal | replacement | | | | |
| sound | | | | | |
| separation | | | | | |

In Table 1, [1] to [4] refer to:
[1] Chenxing Li, Lei Zhu, Shuang Xu, Peng Gao, and Bo Xu, “CBLDNN-based speaker-independent speech separation via generative adversarial training,” in ICASSP, 2018.
[2] Lianwu Chen, Meng Yu, Yanmin Qian, Dan Su, and Dong Yu, “Permutation invariant training of generative adversarial network for monaural speech separation,” in Interspeech, 2018.
[3] Ziqiang Shi, Huibin Lin, Liu Liu, Rujie Liu, Shoji Hayakawa, and Jiqing Han, “Furcax: End-to-end monaural speech separation based on deep gated (de) convolutional neural networks with adversarial example training,” in ICASSP, 2019.
[4] Chengyun Deng, Yi Zhang, Shiqian Ma, Yongtao Sha, Hui Song, and Xiangang Li, “Conv-TasSAN: Separative adversarial network based on conv-tasnet.,” in Interspeech, 2020, pp. 2647-2651.

Previous works find that extending PIT with adversarial training improves their speech source separation systems. Interestingly, SSGAN-PIT reports that all their adversarial variants perform similarly—but variant (i) converges faster when training. SSGAN-PIT also reports that adversarial training alone (without PIT) performs worse. The disclosure differs from previous works on adversarial PIT for speech source separation in many key ways (see Table 1):
The disclosure generalize adversarial PIT for speech source separation to universal sound separation. While prior systems showed that it can work for separating two speakers (K=2), our experiments show that the disclosure's proposed generalized methods and systems for universal sound separation can work to separate four sources (K=4) of any kind.
The disclosure proposed a new context-based discriminator with S-replacement, allowing D_{ctx,S} to provide better guidance when dealing with more than two sources that are heterogeneous (e.g., four sources of any kind). Importantly, in adversarial PIT for speech sound separation the discriminator can judge the realness of ŝₖ focusing on source specific cues—but in adversarial PIT for universal sound separation the discriminator (or discriminators) cannot rely on source specific cues because the model is source agnostic. Experimentally, it was found that the standard adversarial PIT without S-replacement, as in previous works using

$${D}_{ctx , S = 0}^{S T F T} , {D}_{i n s t}^{S T F T} or {D}_{ctx , S = 0}^{w a v e} ,$$

was obtaining non-competitive results for universal sound separation. However, when experimenting with S-replacement strategy the models obtained better results. Hence, embodiments of the present invention includes D_{ctx,S} with S-replacement, enabling generalizing adversarial PIT to universal sound separation, where multiple (e.g., 4) heterogeneous sources (e.g., sources of any kind) have to be separated from a mixture.
Some embodiments of the present disclosure improve the quality of the separations by using multiple discriminators that operate over various domains: magnitude STFT, waveform and masks. As a result, and differently from previous works, the disclosure may rely on several discriminators that guide the separator based on a rich set of cues coming from various domains. Since the direction provided by the multiple discriminators used is rich enough, this allows dropping the regression PIT loss to rely on a purely adversarial setup for the first time.
The disclosure successfully explored using HingeGAN in our experiments, but any other adversarial loss schema (like LSGAN or MetricGAN) should work in principle.

Table 2 show results for various D_{ctx,S} configurations obtained with the example architecture presented above, using the reverberant FUSS dataset with 20 k/1 k/1 k (train/val/test) mixes of 10 s with one to four sources. The m column indicates if D_{ctx,S} is m-conditioned or not. The SI-SNR column indicates SI-SNR_{I}/SI-SNR_{S} in dB, where SI-SNR is the scale-invariant SNR:

$$SI - SNR ( {s}_{k} , {\hat{s}}_{k}^{*} ) = 10 {log}_{10} \frac{{‖ α {s}_{k} ‖}^{2} + ϵ}{{‖ α {s}_{k} - {\hat{s}}_{k}^{*} ‖}^{2} + ϵ}$$

$$where$$

$$α = \frac{{s}_{k}^{T} {\hat{s}}_{k}^{*} + ϵ}{{‖ {s}_{k} ‖}^{2} + ϵ} , ϵ = {10}^{- 5}$$

$$and {\hat{s}}_{k}^{*} = {[ {P}^{*} \hat{s} ]}_{k} .$$

To account for inactive sources, estimate-target pairs that have silent target sources are discarded. For mixes with one source

$$SI - {SNR}_{S} = SI - SNR ( {s}_{k} , {\hat{s}}_{k}^{*} ) ,$$

equivalent to

$$SI - SNR ( m , {\hat{s}}_{k}^{*} )$$

since with one-source mixes the goal is to bypass the mix (the S sub-index here stands for single-source). For mixes with two to four sources, the average is reported across sources of the

$$( SI - {SNR}_{I} = SI - SNR ( {s}_{k} , {\hat{s}}_{k}^{*} ) - SI - SNR ( {s}_{k} , m )$$

(the I sub-index stands for improvement). For comparison against a meaningful state-of-the-art baseline the DCASE model is used, a TDCN++ predicting STFT masks. It is trained on the reverberant FUSS dataset and evaluated with the metrics based on the standard SI-SNR. Finally SI-SNR_{S} are reported for consistency, but SI-SNR_{I} are more relevant for comparing models since most SI-SNR_{S} scores are already very close to the upper-bound of 39.9 dB (see Table 3). The models are trained until convergence (around 500 k iterations) using the Adam optimizer, and the best model on the validation set is selected for evaluation. For training, the learning rate is adjusted to {10⁻⁵, 10⁻⁴, 10⁻³} and batch size {16, 32, 64, 96, 128} such that all experiments, including ablations and baselines, get the best possible results. Finally, a mixture-consistency projection at inference time is used (not during training) because it systematically improved the SI-SNR_{S} without degrading SI-SNR_{I}. The best model was trained for a month with 4 V100 GPUs with a learning rate of 10⁻⁴ and a batch size of 128.

TABLE 2

| m | | SI-SNR | | SI-SNR | | SI-SNR |
|---|---|---|---|---|---|---|
| Yes | S = 0 | 4.9/35.7 | S = 0 | 5.9/35.8 | S = 0 | 8.5/39.9 |
| Yes | S = 1 | 11.0/33.2 | S = 1 | 9.3/33.6 | S = 1 | 11.3/35.5 |
| Yes | S = 2 | 10.7/33.1 | S = 2 | 9.6/34.3 | S = 2 | 11.9/36.3 |
| Yes | S = 3 | 11.7/33.4 | S = 3 | 8.6/32.6 | S = 3 | 12.1/35.9 |
| No | S = 0 | 5.7/35.0 | S = 0 | 3.8/36.8 | S = 0 | 8.5/39.9 |
| No | S = 1 | 9.9/32.8 | S = 1 | 6.7/34.1 | S = 1 | 10.3/37.6 |
| No | S = 2 | 10.4/32.0 | S = 2 | 9.0/33.6 | S = 2 | 11.0/36.0 |
| No | S = 3 | 10.2/31.0 | S = 3 | 9.7/33.5 | S = 3 | 11.4/35.3 |

Table 3 includes a comparison of adversarial PIT variants and baselines. The SI-SNR column indicates SI-SNR_{I}/SI-SNR_{S} in dB. All D_{ctx,S} in Table 3 are m-conditioned with S=3, as it outperforms other setups (Table 2). All adversarial PIT ablations (rows 1-11 and Table 2) use the same f_{θ}.

TABLE 3

| ${ℒ}_{ctx , S}^{STFT}$ | ${ℒ}_{ctx , S}^{STFT}$ | ${ℒ}_{ctx , S}^{mask}$ | ${ℒ}_{inst}^{STFT}$ | ${ℒ}_{inst}^{wave}$ | ${ℒ}_{inst}^{mask}$ | [symbol] _{PIT} | SI-SNR (↑) |
|---|---|---|---|---|---|---|---|
| X | X | X | X | X | X | X | 13.5/37.2 |
| X | X | X | X | X | X | | 12.9/36.7 |
| X | X | X | | | | | 12.5/37.3 |
| X | X | | X | X | | X | 13.8/35.3 |
| X | X | | X | X | | | 12.0/38.3 |
| X | X | | | | | | 11.6/ 35.3 |
| X | | | | | | | 11.7/33.4 |
| | X | | | | | | 12.1/35.9 |
| | | X | | | | | 8.6/32.6 |
| | | | X | | | | 8.2/27.0 |
| | | | | X | | | 4.7/27.7 |
| | | | | | X | | 4.5/36.8 |
| | | | | | | X | 12.4/37.4 |

| | |
|---|---|
| DCASE PIT baseline | 12.8/37.5 |
| Lower-bound: return the input mix m | 0.0/39.9 |
| Upper-bound: ideal ratio STFT masks | 25.3/39.9 |

The person skilled in the art realizes that the present invention by no means is limited to the preferred embodiments described above. On the contrary, many modifications and variations are possible within the scope of the appended claims.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### Interpretation

A computing device implementing the techniques described above can have the following example architecture. Other architectures are possible, including architectures with more or fewer components. In some implementations, the example architecture includes one or more processors (e.g., dual-core Intel® Xeon® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network.

The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present invention discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this invention to “one example embodiment”, “some example embodiments” or “an example embodiment” means that a particular feature, structure or characteristic described in connection with the example embodiment is included in at least one example embodiment of the present invention. Thus, appearances of the phrases “in one example embodiment”, “in some example embodiments” or “in an example embodiment” in various places throughout this invention are not necessarily all referring to the same example embodiment. Furthermore, the particular features, structures or characteristics may be combined in any suitable manner, as would be apparent to one of ordinary skill in the art from this invention, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present invention, various features of the present invention are sometimes grouped together in a single example embodiment, Fig., or description thereof for the purpose of streamlining the present invention and aiding in the understanding of one or more of the various inventive aspects. This method of invention, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this invention.

Furthermore, while some example embodiments described herein include some but not other features included in other example embodiments, combinations of features of different example embodiments are meant to be within the scope of the present invention, and form different example embodiments, as would be understood by those skilled in the art. For example, in the following claims, any of the claimed example embodiments can be used in any combination.

In the description provided herein, numerous specific details are set forth. However, it is understood that example embodiments of the present invention may be practiced without these specific details. In other instances, well-known methods, structures and techniques have not been shown in detail in order not to obscure an understanding of this description.

Thus, while there has been described what are believed to be the best modes of the present invention, those skilled in the art will recognize that other and further modifications may be made thereto without departing from the spirit of the present invention, and it is intended to claim all such changes and modifications as fall within the scope of the present invention. For example, any formulas given above are merely representative of procedures that may be used. Functionality may be added or deleted from the block diagrams and operations may be interchanged among functional blocks. Steps may be added or deleted to methods described within the scope of the present disclosure.

Aspects of example embodiments include the following enumerated example embodiments (“EEEs”):
EEE 1. A method for adversarial training of a separator for universal sound separation of an audio mixture m of arbitrary sound sources s_{k=1, . . . ,K}, the method comprising:
training a context-based discriminator configured to provide a context-based loss cue based on a consideration of an input set of separated sound sources; and
training the separator to minimize a loss based on the context-based loss cue provided by the context-based discriminator;
wherein training the context-based discriminator comprises maximizing a loss based on a set of ground-truth sound sources and a fake set of separated sound sources, wherein the fake set of separated sound sources is sorted to match an order of the set of ground-truth sound sources, and wherein the fake set of separated sound sources comprises sources corresponding to separated sound sources estimated by the separator and further comprises one or more ground-truth sound sources of the set of ground-truth sound sources.
EEE 2. The method according to EEE 1, wherein the fake set of separated sound sources is obtained by:
obtaining a set of separated sound sources corresponding to a set of estimated separated sound sources [ŝ₁, . . . , ŝ_{K}] estimated by the separator from the audio mixture m;
permuting the set of separated sound sources such that an order of the permuted set of separated sound sources matches an order of the set of ground-truth sound sources; and
replacing one or more of the separated sound sources of the permuted set of separated sound sources with one or more ground-truth sound sources of the set of ground-truth sound sources to obtain the fake set of separated sound sources.
EEE 3. The method according to EEE 2, wherein the set of separated sound sources is permuted using a permutation matrix P*, wherein P* is the permutation matrix among a set of all permutation matrices P minimizing a loss between the set of ground truth sources and the set of separated sound sources permuted using P, wherein, optionally, the loss is a permutation invariant loss.
EEE 4. The method according to any one of the preceding EEEs, wherein the context-based discriminator is configured to operate in a waveform domain, a magnitude STFT domain, a filter-bank domain or a mask domain.
EEE 5. The method according to any one of the preceding EEEs, wherein the context-based discriminator is a first context-based discriminator configured to operate in a first domain (e.g. and thus provide a first context-based loss cue based on a consideration of an input set of separated sound sources represented in the first domain) and the method further comprises training a second context-based discriminator configured to operate in a second domain different from the first domain and to provide a second context-based loss cue based on a consideration of an input set of separated sound sources represented in the second domain,
wherein the loss minimized to train the separator is further based on the context-based loss cue provided by the second context-based discriminator (i.e. the loss is based on the first and second context-based loss cues).
EEE 6. The method according to EEE 5, wherein training the second context-based discriminator comprises maximizing a loss based on a representation of the set of ground-truth sound sources in the second domain (i.e. the set of ground-truth sound sources represented in the second domain) and a second fake set of separated sound sources represented in the second domain, wherein the second fake set of separated sound sources is sorted to match an order of the set of ground-truth sound sources (e.g. in the second domain), and wherein the second fake set of separated sound sources comprises sources corresponding to separated sound sources estimated by the separator and further comprises one or more ground-truth sound sources of the set of ground-truth sound sources represented in the second domain.
EEE 7. The method according to any one of EEEs 5-6, wherein the first and second context-based discriminators are configured to operate in a respective one of a waveform domain, a magnitude STFT domain, a filter-bank domain or a mask domain.
EEE 8. The method according to any one of the preceding EEEs, wherein the context-based discriminator is configured to operate in a waveform domain, and wherein the set of ground-truth sound sources [s₁, . . . , s_{K}] and the fake set of separated sound sources [s̅₁, . . . , s̅_{K}] are represented in the waveform domain.
EEE 9. The method according to EEE 8, wherein the fake set of separated sound sources [s̅₁, . . . , s̅_{K}] is obtained by:
obtaining a set of separated sound sources [ŝ1, . . . , ŝ_{K}] represented in the waveform domain and estimated by the separator from the audio mixture m;
permuting the set of separated sound sources [ŝ₁, . . . , ŝ_{K}] such that an order of the permuted set of separated sound sources

$$[ {\hat{s}}_{1}^{*} , … , {\hat{s}}_{K}^{*} ]$$

matches an order or the set of ground-truth sound sources [s₁, . . . , s_{K}]; and
replacing one or more of the separated sound sources

$${\hat{s}}_{k}^{*}$$

of the permuted set of separated sound sources

$$[ {\hat{s}}_{1}^{*} , … , {\hat{s}}_{K}^{*} ]$$

with one or more ground-truth sound sources sₖ of the set of ground-truth sound sources [s₁, . . . , s_{K}] to obtain the fake set of separated sound sources [s̅₁, . . . , s̅_{K}].
EEE 10. The method according to EEE 9, wherein the set of separated sound sources [ŝ₁, . . . , ŝ_{K}] is permuted using a permutation matrix P*,
wherein P* is the permutation matrix minimizing

$${min}_{P} {\sum }_{k = 1}^{K} ℒ ( {s}_{k} , {[ P \hat{s} ]}_{k} ) .$$

EEE 11. The method according to any one of EEEs 8-10, wherein the context-based discriminator is denoted

$${D}_{ctx , S}^{wave}$$

and is trained to maximize

$${ℒ}_{ctx , S} = {ℒ}_{ctx , S}^{real} + {ℒ}_{ctx , S}^{fake} ,$$

where

$${ℒ}_{ctx , S}^{real}$$

is based on

$${D}_{ctx , S}^{wave} ( m , {s}_{1} , … , {s}_{K} )$$

and

$${ℒ}_{ctx , S}^{fake}$$

is based on

$${D}_{ctx , S}^{wave} ( m , {\overline{s}}_{1} , … , {\overline{s}}_{K} )$$

EEE 12. The method according to any one EEEs 1-7, wherein the context-based discriminator is configured to operate in a magnitude STFT domain, and wherein the set of ground-truth sound sources [|S₁|, . . . , |S_{K}|] and the fake set of separated sound sources [|S̅₁|, . . . , |S̅_{K}|] are represented in the magnitude STFT domain.
EEE 13. The method according to EEE 12, wherein the fake set of separated sound sources [|S̅₁|, . . . , |S̅_{K}|] is obtained by:
obtaining a set of separated sound sources [|Ŝ₁|, . . . , |Ŝ_{K}|] represented in the magnitude STFT domain and corresponding to a set of estimated separated sound sources [ŝ₁, . . . , ŝ_{K}] estimated by the separator (30) from the audio mixture m;
permuting the set of separated sound sources [|Ŝ₁|, . . . , |Ŝ_{K}|] such that an order of the permuted set separated sound sources

$$[ \vert {\hat{S}}_{1}^{*} \vert , … , \vert {\hat{S}}_{K}^{*} \vert ]$$

matches an order of the set of ground-truth sound sources [|S₁|, . . . , |S_{K}|]; and
replacing one or more of the separated sound sources

$$\vert {\hat{S}}_{k}^{*} \vert$$

of the permuted set of separated sound sources

$$[ \vert {\hat{S}}_{1}^{*} \vert , … , \vert {\hat{S}}_{K}^{*} \vert ]$$

with one or more ground-truth sound sources |Sₖ| of the set of ground-truth sound sources [|S₁|, . . . , |S_{K}|] to obtain the fake set of separated sound sources [|S̅₁|, . . . , |S̅ₖ|].
EEE 14. The method according to EEE 13, wherein |Sₖ| and |Ŝₖ| denote the magnitude STFTs of the ground-truth sound sources sₖ and the estimated separated sound sources ŝₖ, respectively.
EEE 15. The method according to any one of EEEs 12-14, wherein the context-based discriminator is denoted

$${D}_{ctx , S}^{STFT}$$

and is trained to maximize

$${ℒ}_{ctx , S} = {ℒ}_{ctx , S}^{real} + {ℒ}_{ctx , S}^{fake} ,$$

where

$${ℒ}_{ctx , S}^{real}$$

is based on

$${D}_{ctx , S}^{STFT} ( \vert M \vert , \vert {S}_{1} \vert , … , \vert {S}_{K} \vert )$$

and

$${ℒ}_{ctx , S}^{fake}$$

is based on

$${D}_{ctx , S}^{STFT} ( \vert M \vert , \vert {\overline{S}}_{1} \vert , … , \vert {\overline{S}}_{K} \vert ) ,$$

where M=STFT(m).
EEE 16. The method according to any one EEEs 1-7, wherein the context-based discriminator is configured to operate in a ratio mask domain, and wherein the set of ground-truth sound sources [R₁, . . . , R_{K}] and the fake set of separated sound sources [R̅₁, . . . , R̅_{K}] are represented in the ratio mask domain.
EEE 17. The method according to EEE 16, wherein the fake set of separated sound sources [|R̅₁|, . . . , |R̅ₖ|] is obtained by:
obtaining a set of separated sound sources [\hat{R}₁, . . . , \hat{R}_{K}] represented in the ratio mask domain and corresponding to a set of estimated separated sound sources [ŝ₁, . . . , ŝ_{K}] estimated by the separator from the audio mixture m;
permuting the set of separated sound sources [\hat{R}₁, . . . , \hat{R}_{K}] such that an order of the permuted set of separated sound sources

$$[ {\hat{R}}_{1}^{*} , … , {\hat{R}}_{K}^{*} ]$$

matches an order of the set of ground-truth sound sources [R₁, . . . , R_{K}]; and
replacing one or more of the separated sound sources

$${\hat{R}}_{k}^{*}$$

of the permuted set of separated sound sources

$$[ {\hat{R}}_{1}^{*} , … , {\hat{R}}_{K}^{*} ]$$

with one or more ground-truth sound sources Rₖ of the set of ground-truth sound sources [R₁, . . . , R_{K}] to obtain the fake set of separated sound sources [R̅₁, . . . , R̅_{K}].
EEE 18. The method according to any one of EEEs 16-17, wherein the context-based discriminator is denoted

$${D}_{ctx , S}^{mask}$$

and is trained to maximize

$${ℒ}_{ctx , S} = {ℒ}_{ctx , S}^{real} + {ℒ}_{ctx , S}^{fake}$$

where

$${ℒ}_{ctx , S}^{real}$$

is based on

$${D}_{ctx , S}^{mask} ( \vert M \vert , {R}_{1} , … , {R}_{K} )$$

and

$${ℒ}_{ctx , S}^{fake}$$

is based on

$${D}_{ctx , S}^{mask} ( \vert M \vert , {\overline{R}}_{1} , … , {\overline{R}}_{K} ) ,$$

where M=STFT(m).
EEE 19. The method according to any one of the preceding EEEs, further comprising training an instance-based discriminator configured to provide an instance-based loss cue based on a consideration of an individual separated sound source,
wherein the loss minimized to train the separator is further based on the instance-based loss cue provided by the instance-based discriminator.
EEE 20. The method according to EEE 19, further comprising training the instance-based discriminator by maximizing a loss based on an individual ground-truth sound source of the set of ground-truth sound sources and an individual sound source corresponding to an individual separated sound source estimated by the separator.
EEE 21. The method according to any one of EEEs 19-20, wherein the instance-based discriminator is configured to operate in a waveform domain, a magnitude STFT, a filter-bank domain or a mask domain.
EEE 22. The method according to any one of the EEEs 19-21, wherein the instance-based discriminator is a first instance-based discriminator configured to operate in a first domain (e.g. and thus to provide a first instance-based loss cue based on a consideration of an individual separated sound source represented in the first domain) and the method further comprises training a second instance-based discriminator configured to operate in a second domain different from the first domain and to provide a second instance-based loss cue based on a consideration of an individual separated sound source represented in the second domain,
wherein the loss minimized to train the separator is further based on the second instance-based loss cue provided by the second instance-based discriminator (i.e. the loss is further based on the first and second instance-based loss cues).
EEE 23. The method according to EEE 22, wherein the first and second instance-based discriminators are configured to operate in a respective one of a waveform domain, a magnitude STFT domain, a filter-bank domain or a mask domain.
EEE 24. The method of any one of EEEs 19-23, wherein the instance-based discriminator(s) and the context-based discriminator(s) are jointly trained.
EEE 25. The method according to any one of the preceding EEEs, wherein the separated sounds sources estimated by the separator are in a waveform domain.
EEE 26. A computer program product comprising computer program code portions configured to perform the method according to any one of EEEs 1-24 when executed on a computer processor.
EEE 27. A neural network-based system for universal sound separation of an audio mixture m of arbitrary sound sources s_{k=1, . . . ,K}, wherein the system is configured to perform the method according to any one of EEEs 1-25.
EEE 28. A method for universal sound separation, comprising:
estimating by a separator (30) a set of separated sound sources [ŝ₁, . . . , ŝ_{K}] from an audio mixture m of arbitrary sound sources s_{k=1, . . . ,K}, wherein the separator (30) is trained using the method according to any one of EEEs 1-25.
EEE 29. A neural network-based system for universal sound separation, comprising a separator (30) configured to estimate a set of separated sound sources [ŝ₁, . . . , ŝ_{K}] from an audio mixture m of arbitrary sound sources s_{k=1, . . . ,K}, wherein the separator (30) is trained using the method according to any one of EEEs 1-25.
EEE 30. A neural network-based system for universal sound separation of an audio signal, the system comprising:
a separator configured to estimate a set of separated sound sources from the audio signal;
an instance-based discriminator configured to provide an instance-based loss cue to the separator based on a consideration of a separated sound source of the set of separated sound sources;
a context-based discriminator configured to provide a context-based loss cue to the separator based on a consideration of the set of separated sound sources; and
wherein the separator is configured to minimize a loss based on the instant-based loss cue and/or the context-based loss cue.
EEE 31. The system of EEE 30, wherein the context-based loss cue is determined based on a realness of the set of separated sound sources and/or wherein the instance-based loss cue is determined based on a realness of the separated sound source of the set of separated sound sources.
EEE 32. The system of any one of EEEs 30-31, wherein the instance-based discriminator is trained to maximize:

$${ℒ}_{inst} = \frac{1}{K} {\sum }_{k = 1}^{K} {ℒ}_{inst}^{real , k} + {ℒ}_{inst}^{fake , k} , where$$

$${ℒ}_{inst}^{real , k} = log ( {D}_{inst} ( {s}_{k} ) ) ,$$

$${ℒ}_{inst}^{fake , k} = log ( 1 - {D}_{inst} ( {\hat{s}}_{k} ) ) ,$$

EEE 33. The system of any one of EEEs 30-32, wherein the instance-based discriminator and/or the context-based discriminator is trained based on adversarial training losses including least-squares generative adversarial networks, metric generative adversarial networks, or hinge loss.
EEE 34. The system of EEE 33, wherein the training of the context-based discriminator includes: receiving a set of real separated sound sources; receiving a set of fake separated sound sources, wherein one or more of the fake separated sound sources of the set of fake separated sound sources are ground-truth sources determined based on a permutation matrix; and maximizing a loss based on the set of real separated sound sources and the set of fake separated sound sources.
EEE 35. The system of any one of EEEs 30-34, wherein the instance-based discriminator and the context-based discriminator are configured to operate in the waveform domain, the magnitude STFT, the filter-bank domain, and/or the mask domain.
EEE 36. The system of any one of EEEs 30-35, wherein the instance-based discriminator and the context-based discriminator are jointly trained.
EEE 37. The system of any one of EEEs 30-36, wherein the separator is trained via adversarial training.
EEE 38. The system of any one of EEEs 30-37, wherein the separator is trained via adversarial training together with a permutation invariant loss.
EEE 39. A method for adversarial training of a separator for universal sound separation of an audio mixture m of arbitrary sound sources s_{k=1, . . . ,K}, the method comprising: training a context-based discriminator configured to provide a context-based loss cue based on a consideration of an input set of separated sound sources;
training an instance-based discriminator configured to provide an instance-based loss cue based on a consideration of an individual separated sound source; and
training the separator to minimize a loss based on the context-based loss cue provided by the context-based discriminator and the instance-based loss cue provided by the instance-based discriminator.
EEE 40. The method of EEE 39, wherein the instance-based discriminator and the context-based discriminator are configured to operate in the waveform domain, the magnitude STFT, the filter-bank domain, and/or the mask domain.
EEE 41. The method of any one of EEEs 39-40, wherein the instance-based discriminator and the context-based discriminator are jointly trained.

1. A method for adversarial training of a separator for universal sound separation of an audio mixture m of arbitrary sound sources s_{k=1, . . . ,K}, the method comprising:
training a context-based discriminator configured to provide a context-based loss cue based on a consideration of an input set of separated sound sources; and
training the separator to minimize a loss based on the context-based loss cue provided by the context-based discriminator;
wherein training the context-based discriminator comprises maximizing a loss based on a set of ground-truth sound sources and a fake set of separated sound sources, wherein the fake set of separated sound sources is sorted to match an order of the set of ground-truth sound sources, and wherein the fake set of separated sound sources comprises sources corresponding to separated sound sources estimated by the separator and further comprises one or more ground-truth sound sources of the set of ground-truth sound sources.

2. The method according to claim 1, wherein the fake set of separated sound sources is obtained by:
obtaining a set of separated sound sources corresponding to a set of estimated separated sound sources [ŝ₁, . . . , ŝ_{K}] estimated by the separator from the audio mixture m;
permuting the set of separated sound sources such that an order of the permuted set of separated sound sources matches an order of the set of ground-truth sound sources; and
replacing one or more of the separated sound sources of the permuted set of separated sound sources with one or more ground-truth sound sources of the set of ground-truth sound sources to obtain the fake set of separated sound sources.

3. The method according to claim 2, wherein the set of separated sound sources is permuted using a permutation matrix P*, wherein P* is the permutation matrix among a set of all permutation matrices P minimizing a loss between the set of ground truth sources and the set of separated sound sources permuted using P.

4. The method according to claim 1, wherein the context-based discriminator is configured to operate in a waveform domain, a magnitude STFT domain, a filter-bank domain or a mask domain.

5. The method according to claim 1, wherein the context-based discriminator is a first context-based discriminator configured to operate in a first domain and the method further comprises training a second context-based discriminator configured to operate in a second domain different from the first domain and to provide a second context-based loss cue based on a consideration of an input set of separated sound sources represented in the second domain,
wherein the loss minimized to train the separator is further based on the context-based loss cue provided by the second context-based discriminator.

6. The method according to claim 5, wherein training the second context-based discriminator comprises maximizing a loss based on a representation of the set of ground-truth sound sources in the second domain and a second fake set of separated sound sources represented in the second domain, wherein the second fake set of separated sound sources is sorted to match an order of the set of ground-truth sound sources, and wherein the second fake set of separated sound sources comprises sources corresponding to separated sound sources estimated by the separator and further comprises one or more ground-truth sound sources of the set of ground-truth sound sources represented in the second domain.

7. (canceled)

8. The method according to claim 1, wherein the context-based discriminator is configured to operate in a waveform domain, and wherein the set of ground-truth sound sources [s₁, . . . , S_{K}] and the fake set of separated sound sources [s̅₁, . . . , s̅_{K}] are represented in the waveform domain.

9. The method according to claim 8, wherein the fake set of separated sound sources [s̅₁, . . . , s̅_{K}] is obtained by:
obtaining a set of separated sound sources [ŝ₁, . . . , ŝ_{K}] represented in the waveform domain and estimated by the separator from the audio mixture m;
permuting the set of separated sound sources [ŝ₁, . . . , ŝ_{K}] such that an order of the permuted set of separated sound sources
$$[ {\hat{s}}_{1}^{*} , … , {\hat{s}}_{K}^{*} ]$$
matches an order of the set of ground-truth sound sources [s₁, . . . , s_{K}]; and
replacing one or more of the separated sources
$${\hat{s}}_{k}^{*}$$
of the permuted set of separated sound sources
$$[ {\hat{s}}_{1}^{*} , … , {\hat{s}}_{K}^{*} ]$$
with one or more ground-truth sound sources sₖ of the set of ground-truth sound sources [s₁, . . . , s_{K}] to obtain the fake set of separated sound sources [s̅₁, . . . , s̅_{K}].

10. (canceled)

11. The method according to claim 8, wherein the context-based discriminator is denoted
$${D}_{ctx , S}^{wave}$$
and is trained to maximize
$${ℒ}_{ctx , S} = {ℒ}_{ctx , S}^{real} + {ℒ}_{ctx , S}^{fake} ,$$
where
$${ℒ}_{ctx , S}^{real}$$
is based on
$${D}_{ctx , S}^{wave} ( m , {s}_{1} , … , {s}_{K} )$$
and
$${ℒ}_{ctx , S}^{fake}$$
is based on
$${D}_{ctx , S}^{wave} ( m , {\overline{s}}_{1} , … , {\overline{s}}_{K} ) .$$

12. The method according to claim 1, wherein the context-based discriminator is configured to operate in a magnitude STFT domain, and wherein the set of ground-truth sound sources [|S₁|, . . . , |S_{K}|] and the fake set of separated sound sources [|S̅₁|, . . . , |S̅_{K}|] are represented in the magnitude STFT domain.

13. The method according to claim 12, wherein the fake set of separated sound sources [|S̅₁|, . . . , |S̅ₖ|] is obtained by:
obtaining a set of separated sound sources [|Ŝ₁|, . . . , |Ŝ_{K}|] represented in the magnitude STFT domain and corresponding to a set of estimated separated sound sources [ŝ₁, . . . , ŝ_{K}] estimated by the separator from the audio mixture m;
permuting the set of separated sound sources [|Ŝ₁, . . . , |Ŝ_{K}|] such that an order of the permuted set of separated sound sources
$$[ \vert {\hat{S}}_{1}^{*} \vert , … , \vert {\hat{S}}_{K}^{*} \vert ]$$
matches an order of the set of ground-truth sound sources [|S₁|, . . . , |S_{K}|];
replacing one or more of the separated sound sources
$$\vert {\hat{S}}_{k}^{*} \vert$$
of the permuted set of separated sound sources
$$[ \vert {\hat{S}}_{1}^{*} \vert , … , \vert {\hat{S}}_{K}^{*} \vert ]$$
with one or more ground-truth sound sources |Sₖ| of the set of ground-truth sound sources [|S₁|, . . . , |S_{K}|] to obtain the fake set of separated sound sources [|S̅₁|, . . . , |S̅ₖ|]; and
wherein |Sₖ| and |Ŝₖ| denote the magnitude STFTs of the ground-truth sound sources sₖ and the estimated separated sound sources ŝₖ, respectively.

14. (canceled)

15. The method according to claim 12, wherein the context-based discriminator is denoted
$${D}_{ctx , S}^{STFT}$$
and is trained to maximize
$${ℒ}_{ctx , S} = {ℒ}_{ctx , S}^{real} + {ℒ}_{ctx , S}^{fake} , where {ℒ}_{ctx , S}^{real}$$
is based on
$${D}_{ctx , S}^{STFT} ( \vert M \vert , \vert {S}_{1} \vert , … , \vert {S}_{K} \vert ) and {ℒ}_{ctx , S}^{fake}$$
is based on
$${D}_{ctx , S}^{STFT} ( \vert M \vert , \vert {\overline{S}}_{1} \vert , … , \vert {\overline{S}}_{K} \vert ) ,$$
where M=STFT(m).

16. The method according to claim 1, wherein the context-based discriminator is configured to operate in a ratio mask domain, and wherein the set of ground-truth sound sources [R₁, . . . , R_{K}] and the fake set of separated sound sources [R̅₁, . . . , R̅_{K}] are represented in the ratio mask domain.

17. The method according to claim 16, wherein the fake set of separated sound sources [|R̅₁|, . . . , |R̅ₖ|] is obtained by:
obtaining a set of separated sound sources [\hat{R}₁, . . . , \hat{R}_{K}] represented in the ratio mask domain and corresponding to a set of estimated separated sound sources [ŝ₁, . . . , ŝ_{K}] estimated by the separator from the audio mixture m;
permuting the set of separated sound sources [\hat{R}₁, . . . , \hat{R}_{K}] such that an order of the permuted set of separated sound sources
$$[ {\hat{R}}_{1}^{*} , … , {\hat{R}}_{K}^{*} ]$$
matches an order of the set of ground-truth sound sources [R₁, . . . , R_{K}]; and
replacing one or more of the separated sound sources
$${\hat{R}}_{k}^{*}$$
of the permuted set of separated sound sources
$$[ {\hat{R}}_{1}^{*} , … , {\hat{R}}_{K}^{*} ]$$
with one or more ground-truth sound sources Rₖ of the set of ground-truth sound sources [R₁, . . . , R_{K}] to obtain the fake set of separated sound sources [R̅₁, . . . , R̅_{K}].

18. (canceled)

19. The method according to claim 1, further comprising training an instance-based discriminator configured to provide an instance-based loss cue based on a consideration of an individual separated sound source,
wherein the loss minimized to train the separator is further based on the instance-based loss cue provided by the instance-based discriminator.

20. (canceled)

21. The method according to claim 19, wherein the instance-based discriminator is configured to operate in a waveform domain, a magnitude STFT, a filter-bank domain or a mask domain.

22. The method according to claim 19, wherein the instance-based discriminator is a first instance-based discriminator configured to operate in a first domain and the method further comprises training a second instance-based discriminator configured to operate in a second domain different from the first domain and to provide a second instance-based loss cue based on a consideration of an individual separated sound source represented in the second domain,
wherein the loss minimized to train the separator is further based on the second instance-based loss cue provided by the second instance-based discriminator.

23. (canceled)

24. The method of claim 19, wherein the instance-based discriminator and the context-based discriminator are jointly trained.

25. (canceled)

26. (canceled)

27. A neural network-based system for universal sound separation of an audio mixture m of arbitrary sound sources s_{k=1, . . . ,K}, wherein the system is configured to perform the method according to claim 1.

28. A method for universal sound separation, comprising:
estimating by a separator a set of separated sound sources [ŝ₁, . . . , ŝ_{K}] from an audio mixture m of arbitrary sound sources s_{k=1 . . . ,K}, wherein the separator is trained using the method according to claim 1.

29. (canceled)
